(19) United States
(12) Patent Application Publication
(10) Pub. No.: US 2006/0280059 A1
(43) Pub. Date: Dec. 14, 2006

(54) Optical pickup device

(75) Inventor: Katsumi Fujiwara, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/430,240

(22) Filed: May 9, 2006

(30) Foreign Application Priority Data
May 12, 2005 (JP) 2005-139837

(51) Int. Cl. G11B 7/00

(52) U.S. Cl. 369/44.14

(57) ABSTRACT

An embodiment includes an optical pickup device wherein a beam of light emitted from the light source is converted into parallel beams of light by the collimator lens and is incident on the objective lens at a first divergent angle through the divergent angle changing optical system to be converged in an information recording surface of a first optical information recording medium when information is recorded and/or reproduced from the first optical information recoding medium. The beam of light emitted from the light source is converted into parallel beams of light by the collimator lens and is incident on the objective lens at a second divergent angle different from the first divergent angle through the divergent angle changing optical system to be converged in an information recording surface of a second optical information recording medium.

### BACKGROUND OF THE INVENTION

1. Field of the Invention

The present invention relates to an optical pickup device, and more particularly to an optical pickup device capable of performing proper information recording and/or reproducing in different optical information recording media.

2. Description of Related Art

A rapid progress has recently been made in research and developments of a high-density optical disk system capable of performing information recording/reproducing by using a violet semiconductor laser of a wavelength of about 400 nm. As an example, an optical disk that performs information recording/reproducing with specifications of NA 0.85 and a light source wavelength of 405 nm, i.e., a Blu-Ray disc (BD), information of about 20 to 30 G per surface can be recorded in an optical disk having a diameter of 12 cm and equal in size to a DVD (NA 0.6, light source wavelength 650 nm, and storage capacity 4, 7 GB). In an optical disk that performs information recording/reproducing with specifications of NA 0.65 and a light source wavelength 405 nm, i.e., an HD DVD, information of 15 to 20 GB per surface can be recorded in an optical disk of a diameter 12 cm. In the specification, such a disk will be referred to as a “high-density optical disk” hereinafter.

A value as a product of an optical pickup device is not sufficient when only information can be properly recorded/reproduced in/from one surface of the high-density optical disk. Under the present circumstances, software is expected to be supplied for both of the BD and the HD DVD from home and abroad. Accordingly, there is now a demand for an optical pickup device capable of performing information recording and/or reproducing in any types of high-density optical disks.

One of the problems inherent in the optical pickup device that records and/or reproduces information in a manner compatible to the BD and the HD DVD is that as the BD has a thickness of a protective laser set to about 0.1 mm and the HD DVD has a thickness of a protective layer set to 0.6 mm, the difference in protective layer thickness causes a spherical aberration when the same objective lens is used. Thus, to correct the spherical aberration caused by the difference in the protection layer thickness, certain ingenuity must be exercised when a convergent optical disk of the optical pickup device is designed. When used beams of light vary in wavelength, a diffraction orbicular zone is set in the objective lens to provide a diffraction effect to only one beam of light, whereby the spherical aberration caused by the difference in the protective layer thickness can be corrected. However, as the BD and the HD DVD both use beams of light having short wavelengths of about 405 nm, diffraction cannot be used for correcting the spherical aberration caused by the difference in the protective layer thickness.

JP A 8-203094 discloses a technology of correcting a spherical aberration by disposing a common optical system (including an objective lens), and displacing a collimator lens in an optical axis direction when information recording and/or reproducing is carried out in optical disks different from each other in protection layer thickness while it is not compatible to a BD and an HD DVD.

According to this technology, however, even when parallel beams of light enter one of the optical disks, a divergent beam of light must enter the other optical disk, and image height characteristics are deteriorated in the case of the divergent light entry. Thus, there is a fear that a coma aberration may occur when a tracking operation causes optical axis shifting in an objective lens. Especially, in the case of the high-density optical disk, only a slight coma aberration may disable information recording and/or reproducing. Therefore, countermeasures are necessary.

JP 3511786 discloses a configuration where in a matched state of optical axes between an intermediate lens and an objective lens for changing a divergent angle, parallel beams of light from a collimator lens are received by the intermediate lens to perform a tracking operation. However, integral driving of the intermediate lens and the objective-lens increases inertia to deteriorate tracking followingness. This often becomes a problem especially when the high-density optical disk is rotated at a high speed to record and/or reproduce information. Furthermore, since a large actuator is necessary, an optical pickup device is enlarged and impossibility of pursuing energy conservation is caused.

### SUMMARY OF THE INVENTION

The present invention has been developed with the foregoing problems of the conventional art in mind, and it is an object of the invention to provide an optical pickup device capable of performing proper information recording and/or reproducing in different optical information recording media while making the device compact and achieving energy conservation.

In order to achieve the object, according to a first aspect of the present invention, an optical pickup device comprises:

a carriage base;

a light source mounted on the carriage base;

a collimator lens mounted on the carriage base;

a subcarriage supported so as to be movable with respect to the carriage base;

a first actuator driven to move the subcarriage in an optical axis intersection direction of the collimator lens and a radial direction of an optical information recording medium in/from which information is recorded and/or reproduced, with respect to the carriage base;

a divergent angle changing optical system mounted on the subcarriage;

an objective lens mounted on the subcarriage; and

a second actuator driven to move the objective lens in an optical axis intersection direction of the objective lens and the radial direction of the optical information recording medium, with respect to the subcarriage, wherein:

a beam of light emitted from the light source is converted into parallel beams of light by the collimator lens and is incident on the objective lens at a first divergent angle through the divergent angle changing optical system to be converged in an information recording surface of a first optical information recording medium when information is recorded and/or reproduced from the first optical information recoding medium having a thickness t1 of a protective layer, and

the beam of light emitted from the light source is converted into parallel beams of light by the collimator lens and is incident on the objective lens at a second divergent angle different from the first divergent angle through the divergent angle changing optical system to be converged in an information recording surface of a second optical information recording medium when information is recorded and/or reproduced from the second optical information recording medium having a thickness t2 (≠t1) of a protective layer.

According to the optical pickup device of the first aspect, parallel beams of light are emitted from the collimator lens to the divergent angle changing optical system. Thus, by driving the subcarriage by the first actuator, it is possible to suppress a coma aberration even when optical axis shifting occurs between the collimator lens and the divergent angle optical system.

The second actuator is driven to move the objective lens in the optical axis intersection direction thereof and the radial direction of the optical information recording medium with respect to the subcarriage. Thus, since the second actuator drives the objective lens alone during the tracking operation, miniaturization/low costs can be achieved, excellent responsiveness can be provided, and energy conservation can be achieved.

Therefore, it is possible to provide an optical pickup device capable of performing proper information recording and/or reproducing in different optical information recording media while making the device compact and achieving energy conservation.

“Parallel beams of light” include a divergent beam of light or a convergent beam of light whose wave surface aberration is substantially limited to 0.07 λrms or less even when optical axis shifting occurs.

Preferably, the optical pickup device of the first aspect includes an actuator for moving the objective lens in an optical axis direction thereof with respect to the subcarriage.

According to the optical pickup device of the first aspect, preferably, the second actuator moves the objective lens in an optical axis direction thereof with respect to the subcarriage.

Preferably, the optical pickup device of the first aspect includes reflection member disposed between the divergent angle changing optical system and the objective lens.

As a result, it is possible to limit a thickness of the optical pickup device.

According to the optical pickup device of the first aspect, preferably, when the first actuator moves the subcarriage by a maximum amount and simultaneously the second actuator moves the objective lens by a maximum amount in the same direction as that of the subcarriage, movement limits of the subcarriage and the objective lens are set in positions in which wave surface aberrations of convergent spots on the information recording surface of the first optical recording medium or the second optical information recording medium are 0.07 λrms or less.

As a result, it is possible to suppress generation of a coma aberration when the first and second actuators move the subcarriage and the objective lens by maximum amounts.

According to the optical pickup device of the first aspect, preferably, the movement limits are mechanical limits. The mechanism limits are stoppers or the like which abut on the objective lens or the subcarriage.

According to the optical pickup device of the first aspect, the movement limits are electrical limits. The electrical limit is for detecting a moving amount of the objective lens or the subcarriage to stop the driving thereof.

According to the optical pickup device of the first aspect, preferably, when the second actuator moves the objective lens in an optical axis intersection direction during a tracking or seeking operation, if a movement of the objective lens is limited by the movement limit of the objective lens, the first actuator moves the subcarriage.

As a result, it is possible to move the objective lens over the movement limits.

The “tracking operation” is for causing a convergent spot to follow a track, and the “seeking operation” is for moving the convergent spot to a distant track.

Preferably, the optical pickup device of the first aspect includes a third actuator for moving the carriage base. When the first actuator moves the subcarriage, if a movement of the subcarriage is limited by the movement limit of the subcarriage, the third actuator moves the carriage base.

As a result, when the seeking operation or the like is carried out, it is possible to move the objective lens over the movement limits of the subcarriage and the objective lens.

Preferably, the optical pickup device of the first aspect further comprises a moving amount calculation section for calculating a moving amount of a convergent spot on the information recording surface of the first or second optical information recording medium based on a signal from the outside during the seeking operation, and a judgment section for judging whether the objective lens is limited or not by the movement limit of the objective lens when the second actuator moves the objective lens by an amount equal to the moving amount of the convergent spot calculated by the moving amount calculation section,

wherein when the judgment section judges that the objective lens is limited by the movement limit of the objective lens, the first actuator moves the subcarriage before the second actuator moves the objective lens.

As a result, it is possible to reduce the amount of shifting between the optical axes of the divergent angle changing optical system and the objective lens which has a large influence on the coma aberration of the convergent spot. Hence, it is possible to perform information recording and/or reproducing in a state where a coma aberration generated in the convergent spot is smaller.

Preferably, the optical pickup device of the first aspect comprises the moving amount calculation section for calculating the moving amount of the convergent spot on the information recording surface of the first or second optical information recording medium based on the signal from the outside during the seeking operation, and the judgment section for judging whether the objective lens is limited by the movement limit of the objective lens and whether the subcarriage is limited by the movement limit of the subcarriage when the second actuator moves the objective lens by an amount equal to the moving amount of the convergent spot calculated by the moving amount calculation section and the first actuator moves the subcarriage,

wherein when the judgment section judges that the objective lens is limited by the movement limit of the objective lens and the subcarriage is limited by the movement limit of the subcarriage, the third actuator moves the subcarriage before the first and second actuators move the subcarriage and the objective lens.

As a result, it is possible to carry out the seeking operation in a state where the amount of optical axis shifting is smaller and a coma aberration generated in the convergent spot is smaller, and to improve detection performance of a tracking error signal (TE) used for judging the number of crossed tracks.

Preferably, the optical pickup device of the first aspect includes an eccentricity calculation section for calculating an eccentric component of one rotation cycle of the first or second optical information recording medium. When information is recorded and/or reproduced in the same track for one rotation or more of the first or second optical information recording medium, the first actuator moves the subcarriage in an optical axis orthogonal direction in synchronization with the rotation based on the eccentric component of one rotation cycle.

As a result, the amount of shifting in optical axis between the objective lens and the divergent angle changing optical system can be reduced. Hence, it is possible to perform information recording and/or reproducing in a state where a coma aberration generated in the convergent spot is smaller.

According to the optical pickup device of the first aspect, preferably, the divergent angle changing optical system comprises a plurality of lenses, and at least one of the lenses is moved in an optical axis direction by a fourth actuator.

According to the optical pickup device of the first aspect, the fourth actuator comprises an electromechanical conversion element, a driving member fixed to one end of the electromechanical conversion element, and a movable member connected to at least one of the lenses and held on the driving member so as to be movable, and the electromechanical conversion element is repeatedly expanded and contracted by changing speeds between expansion and contraction directions to move the movable member.

In the fourth actuator, by applying a driving voltage such as a pulse of a saw-tooth waveform to the electromechanical conversion element for a very short time, the electromechanical conversion element can be deformed to slightly expand or contract, and a speed of expansion/contraction can be changed based on a shape of the pulse.

When the electromechanical conversion element is deformed in an expansion or contraction direction at a high speed, the movable member does not follow the movement of the driving member but stays in its position because of inertia of its mass. On the other hand, when the electromechanical conversion element is deformed in an opposite direction at a slower speed, the movable member moves following the movement of the driving member by a friction force generated meanwhile.

Thus, the movable member can be continuously moved in one direction by repeating the expansion/contraction of the electromechanical conversion element. In other words, by using the fourth actuator of high responsiveness, it is possible to move at least one of the lenses connected to the movable member at a high speed and by a very small amount.

Furthermore, when the movable member is held in a fixed position, if power supplying to the electromechanical conversion element is suspended, the movable member is held by a friction force applied between it and the driving member, whereby energy conservation is achieved. The configuration of the actuator is advantageous in that it can be simplified and miniaturized and costs can be reduced.

Thus, according to the optical pickup device, by driving at least one of the lenses arranged between the light source and the objective lens in its optical axis direction, a divergent angle of a beam of light can be highly accurately changed at a high speed. It is possible to realize an optical pickup device compact, low in power consumption, and relatively low in cost.

According to the optical pickup device of the first aspect, preferably, the first actuator comprises an electromechanical conversion element, a driving member fixed to one end of the electromechanical conversion element, and a movable member connected to the subcarriage and held on the driving member so as to be movable, and the electromechanical conversion element is repeatedly expanded and contracted by changing speeds between expansion and contraction directions to move the movable member.

In the first actuator, by applying a driving voltage such as a pulse of a saw-tooth waveform to the electromechanical conversion element for a very short time, the electromechanical conversion element can be deformed to slightly expand or contract, and a speed of expansion/contraction can be changed based on a shape of the pulse.

When the electromechanical conversion element is deformed in an expansion or contraction direction at a high speed, the movable member does not follow the movement of the driving member but stays in its position because of inertia of its mass. On the other hand, when the electromechanical conversion element is deformed in an opposite direction at a slower speed, the movable member moves following the movement of the driving member by a friction force generated meanwhile.

Thus, the movable member can be continuously moved in one direction by repeating the expansion/contraction of the electromechanical conversion element. In other words, by using the first actuator of high responsiveness, it is possible to move at least one of the lenses connected to the movable member at a high speed and by a very small amount.

Furthermore, when the movable member is held in a fixed position, if power supplying to the electromechanical conversion element is suspended, the movable member is held by a friction force applied between it and the driving member, whereby energy conservation is achieved.

Additionally, the configuration of the actuator is advantageous in that it can be simplified and miniaturized and costs can be reduced. In other words, by moving the subcarriage through driving of the first actuator, it is possible to realize an optical pickup device compact, low in power consumption, and relatively low in cost.

According to the optical pickup device of the first aspect, preferably, the first actuator is a voice coil motor.

According to the optical pickup device of the first aspect, the subcarriage is supported by a leaf spring. As a result, by matching a thickness direction of the leaf spring with a moving direction of the subcarriage, it is possible to easily realize a configuration which regulates movements in directions other than the moving direction.

According to the optical pickup device of the first aspect, preferably, a beam of light having a wavelength λ1=405±20 nm is emitted from the light source, and one of the thickness t1 of the protective layer of the first optical information recording medium and the thickness t2 of the protective layer of the second optical information recording medium is 0.1 mm and the other is 0.6 mm. As a result, it is possible to perform information recording and/or reproducing in a BD and an HD DVD in a compatible manner.

Preferably, the optical pickup device of the first aspect includes another light source for emitting a beam of light having a wavelength λ2=655±30 nm. The beam of light having the wavelength λ2 is converged in an information recording surface of an optical information recording medium different from the first and second optical information recording media through the objective lens. As a result, it is possible to perform information recording/reproducing in a DVD in a compatible manner.

Preferably, the optical pickup device of the first aspect includes another light source for emitting a beam of light having a wavelength λ3=785±30 nm. The beam of light having the wavelength λ3 is converged in an information recording surface of an optical information recording medium different from the first and second optical information recording media through the objective lens. As a result, it is possible to perform information recording/reproducing in a CD in a compatible manner.

In the specification, the “lenses” include not only a lens of a curved surface such as a molded plastic lens but also a lens constituted of a hologram or a diffraction grating, a GRIN lens or the like. These lenses do not always need to have image forming performance. They are only required to refract and emit an incident ray so that the ray made incident on the optical element constituted of the lens can be changed for its divergent angle to be emitted.

### BRIEF DESCRIPTION OF THE DRAWINGS

FIG. 1A is a schematic upper surface diagram of a configuration of an optical pickup device according to an embodiment, showing a state when a BD is used.

FIG. 1B is a diagram of the configuration of FIG. 1A cut on a line IB-IB and seen in an arrow direction.

FIG. 2A is a schematic upper surface diagram of the optical pickup device of the embodiment, showing a state when an HD DVD is used.

FIG. 2B is a diagram of the configuration of FIG. 2A cut on a line IIB-IIB and seen in an arrow direction.

FIG. 3 is a perspective diagram showing a laminated piezoelectric actuator of a structure in which a plurality of piezoelectric ceramics PE are stacked together and electrodes C are connected in parallel therebetween.

FIGS. 4A and 4B are diagrams showing waveforms of voltage pulses applied to the piezoelectric actuator.

FIGS. 5A and 5B are diagrams showing examples of movement limits of a subcarriage SC and an objective lens OBJ.

FIG. 6 is a flowchart showing a control example of a seeking operation.

FIG. 7 is a flowchart showing a control example of a seeking operation.

FIGS. 8A to 8C are diagrams showing eccentric components in an optical disk such as a BD or an HD DVD.

### PREFERRED EMBODIMENT OF THE INVENTION

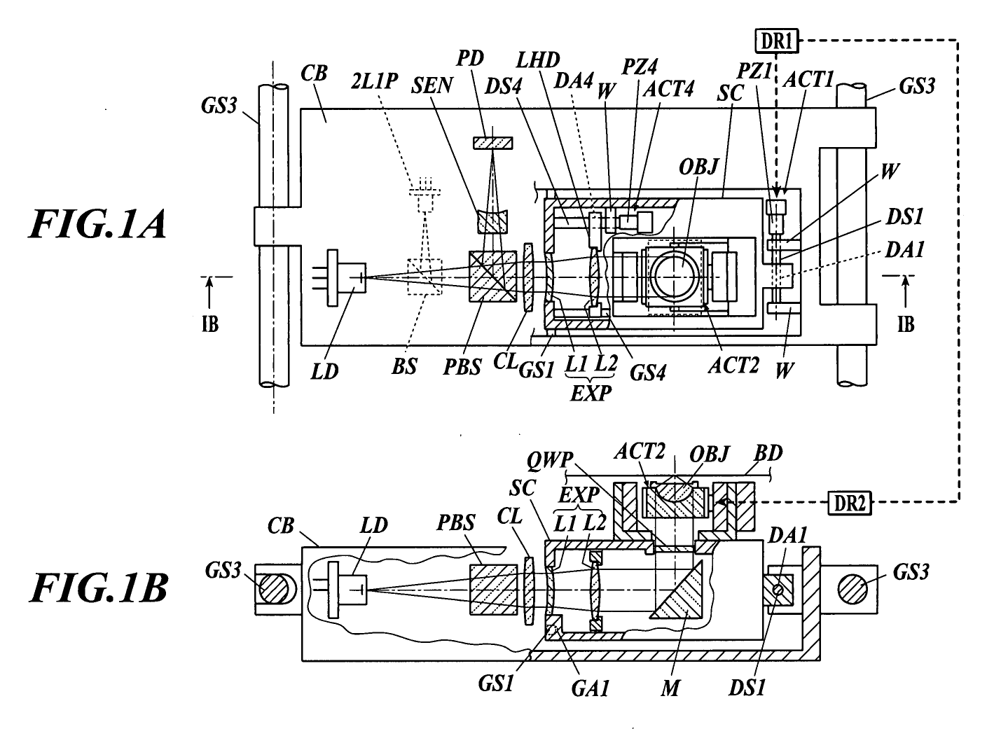

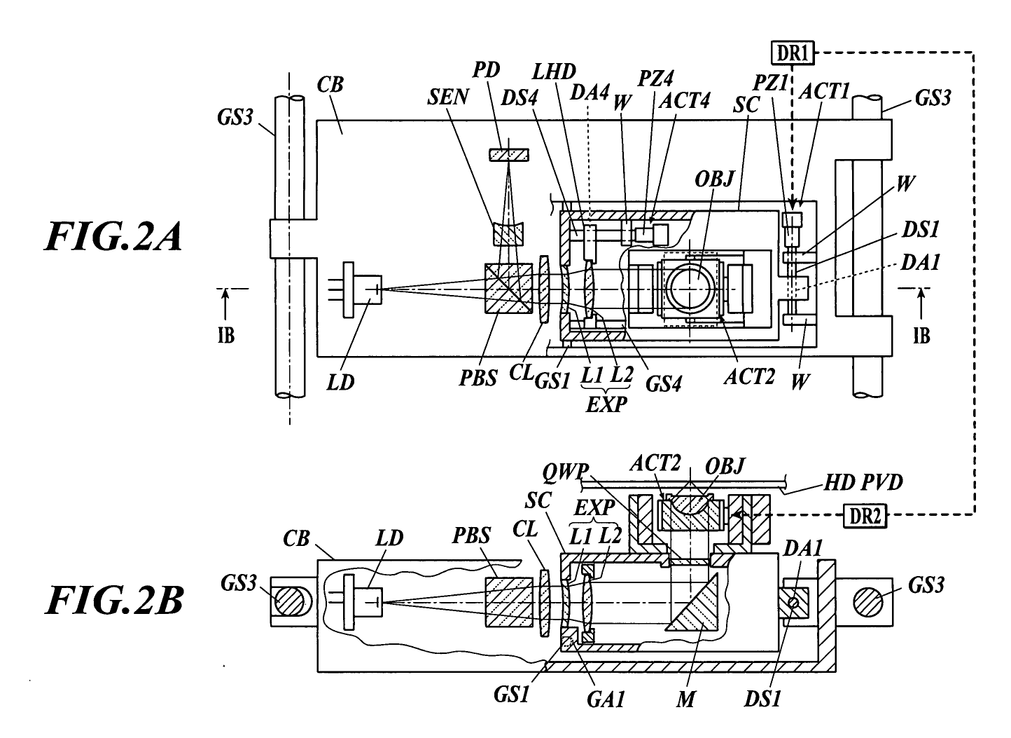

The preferred embodiment of the present invention will be described below with reference to the accompanying drawings. FIG. 1A is a schematic upper surface diagram of a configuration of an optical pickup device capable of performing proper information recording and/or reproducing in a BD and an HD DVD which are optical information recording media (or optical disks) different in protection layer thickness according to a the embodiment, showing a state when the BD is used. FIG. 1B is a diagram of the configuration of FIG. 1A cut on a line IB-IB and seen in an arrow direction. FIG. 2A is a schematic upper surface diagram of the configuration of the optical pickup device of the embodiment, showing a state when the HD DVD is used. FIG. 2B is a diagram of the configuration of FIG. 2B cut on a line IIB-IIB and seen in an arrow direction.

In FIGS. 1A to 2B, a carriage base CB is arranged to move along two guide shafts GS3 extending in parallel by an actuator (third actuator, not shown). A semiconductor laser LD, a polarized beam splitter PBS, a sensor lens SEN, a photodetector PD, and a collimator lens CL are arranged on the carriage base CB.

On the carriage base CB, a subcarriage SC is additionally arranged so that it is driven by a first actuator ACT1 to move along a guide shaft GS1 parallel to the guide shaft GS3.

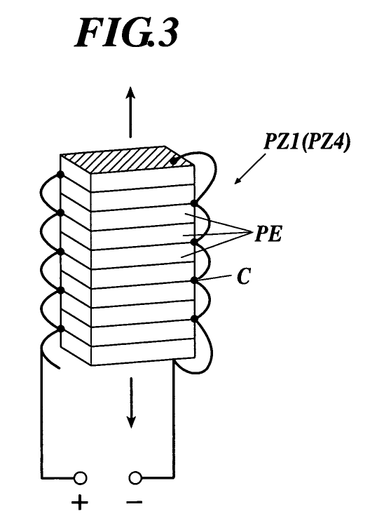

The first actuator ACT1 includes a piezoelectric actuator PZ1 which is an electromechanical conversion element having its rear end (upper end in FIG. 1A) fixed on the carriage base CB. The piezoelectric actuator PZ1 is constructed by staking piezoelectric ceramics made of lead zirconate titanate (PZT) or the like. The piezoelectric ceramics has a nature where positive and negative charges in a crystal grating are not matched with each other in center of gravity, and it is polarized itself, and elongated when a voltage is applied in its polarizing direction. However, distortion of the piezoelectric ceramics in this direction is very small, and it is difficult to drive a member to be driven by this distortion amount. Thus, as shown in FIG. 3, there has been provided a laminated piezoelectric actuator PZ1 which has a structure having a plurality of piezoelectric ceramics PE stacked and electrodes C connected in parallel therebetween and which can be put to practical use. According to the embodiment, this laminated piezoelectric actuator PZ1 is used as a driving source.

A drive shaft DS1 that is a driving member is mounted to a front end (lower end in FIG. 1A) of the piezoelectric actuator PZ1. The drive shaft DS1 in a cantilever state penetrates a wall W of the carriage base CB and engages a driving hole DA1 of the subcarriage SC which is a movable member with a proper friction force.

The subcarriage SC is guided by the guide shaft GS1 engaged in its guide groove GA1 to move with respect to the carriage base CB. An external drive circuit DR1 that applies a voltage through a wiring line (not shown) is arranged to drive and control the piezoelectric actuator PZ1 upon reception of a signal (position information) from an encoder (a position information acquisition section, not shown, e.g., magnetic information can be arranged in the guide shaft GS1, and reading head can be disposed in the subcarriage SC) for magnetically (or optically) detecting a moving amount of the subcarriage SC. A configuration of no encoder is possible.

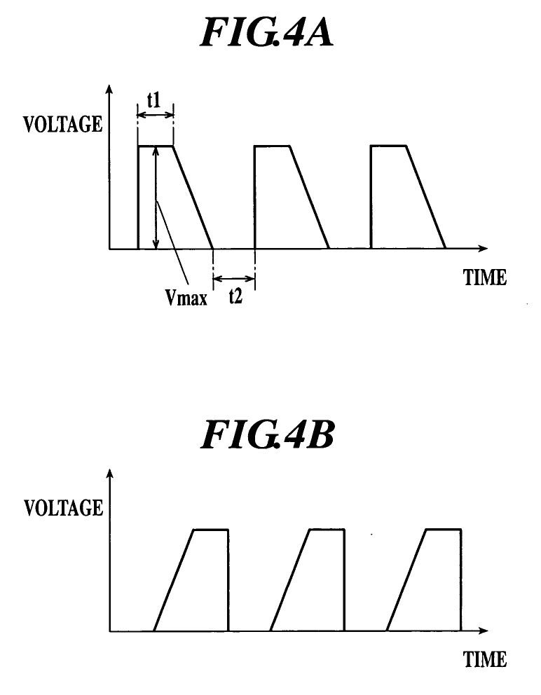

Next, a method of driving the subcarriage SC will be described. Generally, the laminated piezoelectric actuator has a large generation force and sharp responsiveness while a displacement amount is small during voltage application. Accordingly, as shown in FIG. 4A, when a pulse voltage of a roughly saw-tooth waveform which rises sharply but falls slowly is applied, the piezoelectric actuator PZ1 steeply expands at the time of pulse rising, and slowly contracts at the time of falling. Thus, during the expansion of the piezoelectric actuator PZ1, the drive shaft DS1 is pushed out to the lower side of FIG. 1A by its impact force, while the subcarriage SC does not move together with the drive shaft DS1 because of its inertia and stays there by generating sliding between the drive shaft DS1 and the driving hole DA1 (may move slightly). On the other hand, since the drive shaft DS1 slowly returns at the time of pulse falling as compared with that at the time of pulse rising, the driving hole DA1 moves to the upper side of FIG. 1A integrally with the drive shaft DS1 without sliding with respect to the drive shaft DS1. In other words, by applying a pulse having a frequency set to several hundred to several tens of thousand, it is possible to continuously move the subcarriage SC at a desired speed. As apparent from the above, the subcarriage SC can be moved in an opposite direction by applying a pulse of slow voltage rising but sharp falling as shown in FIG. 4B.

On the subcarriage SC, there are arranged an expander lens EXP (constituted of lenses L1 and L2) as a divergent angle changing optical system, a rising mirror M as reflection member, a λ/4 wavelength plate QWP, an objective lens OBJ, and a second actuator ACT2 for driving the objective lens OBJ with respect to the subcarriage SC to move in an optical axis direction and an optical axis orthogonal direction. The second actuator ACT2 is driven and controlled by a drive circuit DR2.

On the subcarriage SC, the lens L1 of the expander lens EXP is fixed while the lens L2 is supported by a guide shaft GS4 extending in parallel with its optical axis direction, and driven to move in the optical axis direction by a fourth actuator ACT4.

The fourth actuator ACT4 includes a piezoelectric actuator PZ4 which is an electromechanical conversion element having its rear end (right end in FIG. 1A) fixed on the subcarriage SC. The piezoelectric actuator PZ4 is constructed by staking piezoelectric ceramics made of lead zirconate titanate (PZT) or the like. The piezoelectric ceramics has a nature where positive and negative charges in a crystal grating are not matched with each other in center of gravity, and it is polarized itself, and elongated when a voltage is applied in its polarizing direction. However, distortion of the piezoelectric ceramics in this direction is very small, and it is difficult to drive a member to be driven by this distortion amount. Thus, as shown in FIG. 3, there has been provided a laminated piezoelectric actuator PZ4 which has a structure having a plurality of piezoelectric ceramics PE stacked and electrodes C connected in parallel therebetween and which can be put to practical use. According to the embodiment, this laminated piezoelectric actuator PZ4 is used as a driving source.

A drive shaft DS4 that is a driving member is mounted to a front end (left end in FIG. 1A) of the piezoelectric actuator PZ1. The drive shaft DS4 in a cantilever state penetrates the wall W of the subcarriage SC and engages a driving hole DA4 of a lens holder LHD of he lens L2 which is a movable member with a proper friction force.

Next, a method of driving the lens L2 will be described. Generally, the laminated piezoelectric actuator has a large generation force and sharp responsiveness while a displacement amount is small during voltage application. Accordingly, as shown in FIG. 4A, when a pulse voltage of a roughly saw-tooth waveform which rises sharply but falls slowly is applied, the piezoelectric actuator PZ4 steeply expands at the time of pulse rising, and slowly contracts at the time of falling. Thus, during the expansion of the piezoelectric actuator PZ4, the drive shaft DS4 is pushed out to the left side of FIG. 1A by its impact force, while the lens holder LHD of the lens L2 does not move together with the drive shaft DS4 because of its inertia and stays there by generating sliding between the drive shaft DS4 and the driving hole DA4 (may move slightly). On the other hand, since the drive shaft DS4 slowly returns at the time of pulse falling as compared with that at the time of pulse rising, the driving hole DA4 moves to the right side of FIG. 1A integrally with the drive shaft DS4 without sliding with respect to the drive shaft DS4. In other words, by applying a pulse having a frequency set to several hundred to several tens of thousand, it is possible to continuously move the lens holder LHD together with the lens L2 at a desired speed. As apparent from the above, the lens holder LHD can be moved in an opposite direction by applying a pulse of slow voltage rising but sharp falling as shown in FIG. 4B.

An operation of the optical pickup device of the embodiment will be described. When information is recorded and/or reproduced in the BD which is a first optical information medium, the fourth actuator ACT4 is driven to move the lens L2 to the rising mirror M side as shown in FIGS. 1A and 1B. In this state, a beam of light of a light source wavelength 405±20 nm emitted from the semiconductor laser LD (light source) passes through the polarized beam splitter PBS to be converted into parallel beams of light by the collimator CL, and then passes through the expander lens EXP to be converted into parallel beams of light (divergent angle 0) increased in diameter, and made incident on the rising mirror M.

In FIG. 1B, a part of the beams of light made incident on the rising mirror M is transmitted therethrough, and then made incident on a laser power monitor (not shown) positioned behind the rising mirror M to be used for monitoring laser power. On the other hand, the rest of the beams of light made incident on the rising mirror M is reflected, passed through the ¼ wavelength plate QWP, and then made incident on the objective lens OBJ to be converged in the information recording surface (thickness of protective layer is 0.1 mm) of the BD.

A beam of light reflected on the information recording surface of the BD by an information pit passes through the objective lens OBJ and the ¼ wavelength plate QWP to be reflected again by the rising mirror M, then passes through the expander lens EXP and the collimator lens CL to be reflected by the polarized beam splitter PBS, and converged in a light receiving surface of a photodetector (light receiving element, similar hereinafter) PD by a sensor lens SEN. A reading signal of information recorded in the BD is obtained by using an output signal of the photodetector PD.

A light quantity change caused by a shape or position change of a spot on the photodetector PD is detected to carry out focus or track detection. The second actuator ACT2 moves the objective lens OBJ with respect to the subcarriage SC for focusing or tracking based on the detection so that a beam of light from the semiconductor laser LD can properly form an image on the information recording surface of the BD.

When information is recorded and/or reproduced in the HD DVD which is a second optical information medium, the fourth actuator ACT4 is driven to move the lens L2 to the semiconductor laser LD side as shown in FIGS. 2A and 2B. In this state, a beam of light of a light source wavelength 405±20 nm emitted from the semiconductor laser LD passes through the polarized beam splitter PBS to be converted into parallel beams of light by the collimator CL, and then passes through the expander lens EXP to be converted into parallel beams of light (divergent angle>0°) increased in diameter, and made incident on the rising mirror M.

In FIG. 2B, a part of the beams of light made incident on the rising mirror M is transmitted therethrough, and then made incident on the laser power monitor (not shown) positioned behind the rising mirror M to be used for monitoring laser power. On the other hand, the rest of the beams of light made incident on the rising mirror M is reflected, passed through the ¼ wavelength plate QWP, and then made incident on the objective lens OBJ to be converged in the information recording surface (thickness of protective layer is 0.6 mm) of the HD DVD. As the divergent beam of light is made incident on the objective lens OBJ, even when a common objective lens OBJ is used, it is possible to correct a spherical aberration caused by a difference in protective layer thickness between the BD and the HD DVD.

A beam of light reflected on the information recording surface of the HD DVD by an information pit passes through the objective lens OBJ and the ¼ wavelength plate QWP to be reflected again by the rising mirror M, then passes through the expander lens EXP and the collimator lens CL to be reflected by the polarized beam splitter PBS, and converged in the light receiving surface of the photodetector (light receiving element, similar hereinafter) PD by the sensor lens SEN. A reading signal of information recorded in the HD DVD is obtained by using an output signal of the photodetector PD.

A light quantity change caused by a shape or position change of a spot on the photodetector PD is detected to carry out focus or track detection. The second actuator ACT2 moves the objective lens OBJ with respect to the subcarriage SC for focusing or tracking based on the detection so that a beam of light from the semiconductor laser LD can properly form an image on the information recording surface of the HD DVD.

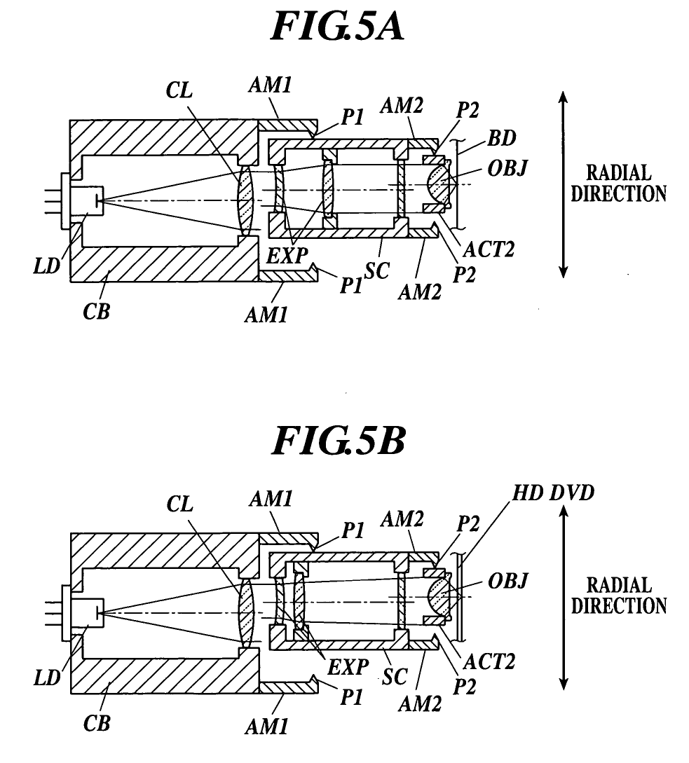

The movement limits will be described with reference to the drawings. FIGS. 5A and 5B are diagrams showing examples of movement limits of the subcarriage SC and the objective lens OBJ. FIG. 5A shows a state when the BD is used, and FIG. 5B shows a state when the HD DVD is used. The first actuator, the support mechanism of the subcarriage, the second actuator, and the support mechanism of the second actuator are omitted.

In FIGS. 5A and 5B, a pair of arms AM1 and AM1 extend from the end (right end in the drawings) of the carriage base CB to the subcarriage SC side. A projection p1 is formed in a tip of each first arm AM1. The subcarriage SC is arranged between the projections p1 and p1. The subcarriage SC abuts on one of the projections p1 to be limited for further movement when it moves in an optical axis orthogonal direction. A pair of second arms AM2 and AM2 extent from the end (right end in the drawings) of the subcarriage SC to the objective lens OBJ side. A projection p2 is formed in a tip of each second arm AM2. The objective lens OBJ is arranged between the projections p2 and p2. The objective lens OBJ abuts on one of the projections p2 to be limited for further movement (in this example, via the second actuator ACT2 moved integrally with the objective lens OBJ) when it moves in the optical axis orthogonal direction. The projection p1 constitutes a movement limit of the subcarriage SC, and the projection p2 constitutes a movement limit of the objective lens OBJ.

In this case, as shown in FIGS. 5A and 5B, the projections p1 and p2 are arranged in positions so that wave surface aberrations of convergent spots on the information recording surfaces of the BD (FIG. 5A) and the HD DVD (FIG. 5B) can be equal to or less than 0.07 λrms when the first actuator ACT1 moves the subcarriage SC by a maximum amount (to abut on the projection p1) and simultaneously the second actuator ACT2 moves the objective lens OBJ by a maximum amount in the same direction as that of the subcarriage SC (to abut on the projection p2). Accordingly, it is possible to suppress generation of a coma aberration when the first actuator ACT1 (not shown) and the second actuator ACT2 move the subcarriage SC and the objective lens OBJ by maximum amounts for a tracking operation or the like. Reaching of the subcarriage SC or the objective lens OBJ to the projection p1 or p2 can be detected based on a signal from an impact sensor or a change in a TE waveform. In place of such mechanical limits as the projections p1 and p2, electrical limits (e.g., when positions of the subcarriage SC and the objective lens OBJ are measured by an optical sensor or a magnetic sensor, or when reaching to the limit position is detected by a current value limit of the actuator, further driving is suspended) may be disposed.

However, after the movements of the subcarriage SC and the objective lens OBJ are limited by the projections p1 and p2, the first and second actuators ACT1 and ACT2 can no longer move the subcarriage SC and the objective lens OBJ in the optical axis orthogonal direction. In such a case, the entire optical pickup device including the objective lens can be moved together with the carriage base CB in the optical axis orthogonal direction by using a third actuator (not shown). Thus, it is possible to carry out a seeking operation over the movement limits.

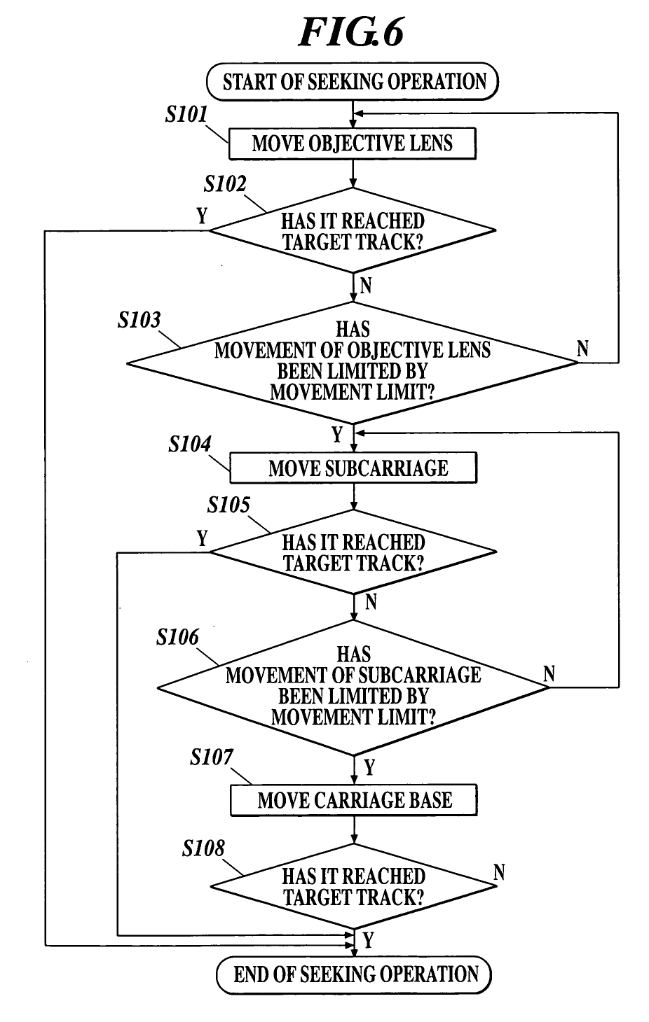

Specific control of the seeking operation will be described with reference to the drawings. FIG. 6 is a flowchart showing a control example of the seeking operation. In FIG. 6, when a seeking operation is requested, in step S101, the second actuator ACT2 is driven and controlled to move the objective lens OBJ in an optical axis orthogonal direction. In subsequent step S102, judgment is made as to whether a convergent spot has reached a target track or not. A control flow is finished if it has reached the target track. If it has not reached the target track, in step S102, judgment is made as to whether the objective lens OBJ has reached the projection p2 or not. If the objective lens OBJ has not reached the projection p2, the process returns to the step S101 to continue the driving and controlling of the second actuator ACT2. On the other hand, if the objective lens OBJ has reached the projection p2, in step S104, the first actuator ACT1 moves the subcarriage SC in the optical axis orthogonal direction.

In step S105, judgment is made as to whether the convergent spot has reached the target track or not. If it has reached the target track, the control flow is finished. If it has not reached the target track, in step S106, judgment is made as to whether the subcarriage SC has reached the projection p1 or not. If the subcarraige SC has not reached the projection p1, the process returns to the step S104 to continue the driving and controlling of the first actuator ACT1. On the other hand, if the subcarriage SC has reached the projection p1, in step S107, the third actuator (not shown) moves the carriage base CB in the optical axis orthogonal direction. In step S108, judgment is made as to whether the convergent spot has reached the target track or not. If it has reached the target track, the control flow is finished. If it has not reached the target track, the process returns to the step S107 to continue the driving and controlling of the third actuator.

The drive circuit DR2 obtains a moving amount of the convergent spot on the information recording surface of the BD or the HD DVD based on a signal from the outside when the seeking operation is carried out, judges whether the objective lens OBJ is limited or not by the movement limit (projection p2) of the objective lens OBJ or not when the second actuator ACT2 moves the objective lens by an amount equal to the obtained moving amount of the convergent spot. If the objective lens OBJ is judged to be limited by the movement limit of the objective lens OBJ, a signal is transmitted to the drive circuit DR1, and the first actuator ACT1 moves the subcarriage SC. Thus, it is possible to easily move the objective lens OBJ over the movement limit of the objective lens OBJ. The drive circuits DR2 and DR1 constitute a moving amount calculation section and a judgment section.

Alternatively, the drive circuits DR2 and DR1 obtain a moving amount of the convergent spot on the information recording surface of the BD or the HD DVD based on a signal from the outside when the seeking operation is carried out, judge whether the objective lens OBJ is limited or not by the movement limit (projection p2) of the objective lens OBJ or not and the subcarriage SC is limited or not by the movement limit (projection p2) of the subcarriage SC when the second actuator ACT2 moves the objective lens OBJ and the first actuator ACT1 moves the subcarriage SC by amounts equal to the obtained moving amount of the convergent spot. If the objective lens OBJ is judged to be limited by the movement limit of the objective lens OBJ and the subcarriage SC is judged to be limited by the movement limit of the subcarriage SC, the third actuator (not shown) moves the carriage base CB.

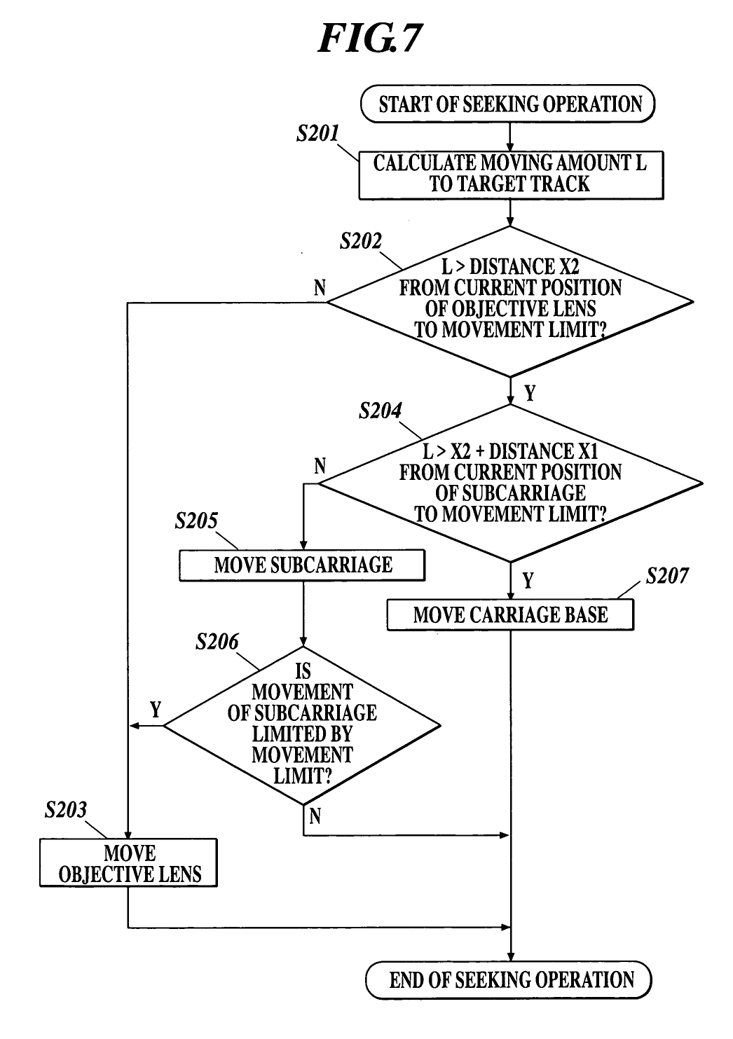

Specific control of the seeking operation will be described with reference to the drawings. FIG. 7 is a flowchart showing a control example of a seeking operation. In FIG. 7, when a seeking operation is requested, in step S201, a moving distance L from a convergent spot to a target track to be reached is calculated. In step S202, judgment is made as to whether the calculated moving distance L exceeds a distance X2 from a current position of the objective lens OBJ to the projection p2 or not. If L≦X2 is judged, in step S203, the second actuator ACT2 is driven and controlled to move the objective lens OBJ, whereby the convergent spot is converged in the target track.

On the other hand, if L>X2 is judged, in step S204, judgment is made as to whether the calculated moving distance L exceeds a total (X2+X1) of the distance X2 from the current position of the objective lens OBJ to the projection p2 and a distance X1 from a current position of the subcarriage SC to the projection p1 or not. If L<(X2+X1) is judged, in step S205, first, the first actuator ACT1 is driven and controlled to move the subcarriage SC, whereby the convergent spot is converged in the target track. In this case, if the convergent spot reaches the target track, the seeking operation is finished. If it is judged in the step S206 that the subcarriage SC is limited by the movement limit by the projection p1 before the convergent spot reaches the target track, in step S203, the second actuator ACT2 is driven and controlled to move the objective lens OBJ, whereby the convergent spot is converged in the target track.

On the other hand, if L>(X2+X1) is judged, in step S207, the third actuator is driven and controlled to move the carriage base CB, whereby the convergent spot is converged in the target track.

According to the embodiment, as parallel beams of light are emitted from the collimator lens CL to the expander lens EXP, through driving of the subcarriage SC by the first actuator ACT1, it is possible to suppress a coma aberration even when optical axis shifting occurs between the collimator lens CL and the expander lens EXP. The second actuator ACT2 drives the objective lens OBJ to move independently in its optical axis direction and its optical axis orthogonal direction with respect to the subcarriage SC. Thus, as the second actuator ACT2 drives the objective lens OBJ alone during the focusing or tracking operation, miniaturization and low costs can be achieved, high responsiveness can be provided, and energy conservation can be achieved.

A detector may be provided as an eccentricity calculation section for calculating an eccentric component of one rotational cycle of the BD or the HD DVD. When information is recorded and/or reproduced in the same track for one rotation or more of the BD or the HD DVD, the first actuator ACT1 may move the subcarriage SC in the optical axis orthogonal direction in synchronization with the rotation based on the eccentric component of one rotational cycle.

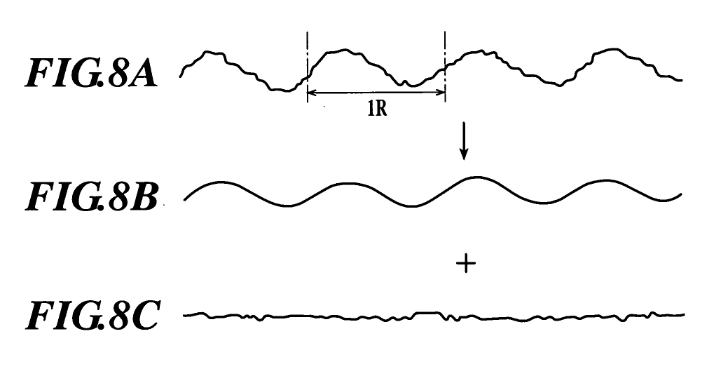

FIGS. 8A to 8C show eccentric components in an optical disk such as a BD or a HD DVD, where an ordinate indicates a track displacement amount, an abscissa indicates a rotational angle, and one rotation is denoted by 1R. In the case of an actual tracking operation, the objective lens operates in a waveform shown in FIG. 8A, which can be divided into a disk eccentric component of a low frequency dependent on rotation shown in FIG. 8B, and an eccentric component of a high frequency shown in FIG. 8C. In the case of a tracking operation in the same track, a track displacement amount is mainly constituted of a disk eccentric component. For an eccentric component of one rotational cycle having relatively large displacement, the subcarriage SC follows up so that shifting can be reduced between the optical axis of the objective lens OBJ moved by the second actuator ACT2 and the optical axis of the divergent angle changing optical system mounted on the subcarriage SC, and a coma aberration generated in the convergent spot can be reduced.

In other words, according to the embodiment, the disk eccentric component of a low frequency can be cancelled through the movement of the subcarriage SC in the optical axis orthogonal direction by the first actuator ACT1. The eccentric component of a high frequency can be canceled through the movement of the objective lens OBJ in the optical axis orthogonal direction by the second actuator ACT2. Hence, it is possible to perform proper information recording and/or reproducing even in the high-density optical disk.

It can therefore be said that the first actuator ACT1 is preferably a type capable of securing a moving distance rather than responsiveness, and the second actuator ACT2 is preferably a type capable of securing responsiveness rather than a moving distance.

The first actuator ACT1 may be a voice coil motor. In such a case, the subcarriage SC is preferably supported by a leaf spring.

By disposing a so-called 2-laser 1-package 2L1P where a semiconductor laser for emitting a beam of light of a wavelength λ2=655±30 nm and a semiconductor laser for emitting a beam of light of a wavelength λ3=785±30 nm are mounted to the same heat sink to constitute one unit, and a beam splitter BS, it is possible to provide an optical pickup device capable of performing information recording and/or reproducing in four different optical disks, a BD, A HD DVD, a DVD, and a CD, in a compatible manner. In this case, the lens L2 of the expander lens EXP is moved according to a thickness of a protective layer of each of the DVD and the CD. A diffraction effect can be used in a compatible manner depending on a wavelength difference.

According to the present invention, by detecting a coma aberration signal at the photodetector PD and moving the subcarriage SC and the objective lens OBJ to optimize the coma aberration signal, it is possible to correct a spot coma aberration on the information recording surface.

The preferred embodiment of the present invention has been described. However, the embodiment is in no way limitative of the invention. Changes and modifications can be made as occasion demands. The 2-laser 1-packet may be a combination of a first semiconductor laser LD 1 and the second semiconductor laser LD 2. The actuator is not limited to that of the embodiment. A stepping motor, a voice coil motor, a shape-memory alloy, or the like can be used.

The entire disclosure of Japanese Patent Application No. Tokugan 2005-139837 filed on May 12, 2005 including specification, claims, drawings and summary are incorporated herein by reference in its entirety.

What is claimed is:

1. An optical pickup device comprising:
a carriage base;
a light source mounted on the carriage base;
a collimator lens mounted on the carriage base;
a subcarriage supported so as to be movable with respect to the carriage base;
a first actuator driven to move the subcarriage in an optical axis intersection direction of the collimator lens and a radial direction of an optical information recording medium in/from which information is recorded and/or reproduced, with respect to the carriage base;
a divergent angle changing optical system mounted on the subcarriage;
an objective lens mounted on the subcarriage; and
a second actuator driven to move the objective lens in an optical axis intersection direction of the objective lens and the radial direction of the optical information recording medium, with respect to the subcarriage, wherein:
a beam of light emitted from the light source is converted into parallel beams of light by the collimator lens and is incident on the objective lens at a first divergent angle through the divergent angle changing optical system to be converged in an information recording surface of a first optical information recording medium when information is recorded and/or reproduced from the first optical information recoding medium having a thickness t1 of a protective layer, and
the beam of light emitted from the light source is converted into parallel beams of light by the collimator lens and is incident on the objective lens at a second divergent angle different from the first divergent angle through the divergent angle changing optical system to be converged in an information recording surface of a second optical information recording medium when information is recorded and/or reproduced from the second optical information recording medium having a thickness t2(≠t1) of a protective layer.

2. The optical pickup device of claim 1, further comprising an actuator for moving the objective lens in an optical axis direction thereof with respect to the subcarriage.

3. The optical pickup device of claim 1, wherein the second actuator moves the objective lens in an optical axis direction thereof with respect to the subcarriage.

4. The optical pickup device of claim 1, further comprising reflection member disposed between the divergent angle changing optical system and the objective lens.

5. The optical pickup device of claim 1, wherein when the first actuator moves the subcarriage by a maximum amount and simultaneously the second actuator moves the objective lens by a maximum amount in the same direction as that of the subcarriage, movement limits of the subcarriage and the objective lens are set in positions in which wave surface aberrations of convergent spots on the information recording surface of the first optical recording medium or the second optical information recording medium are 0.07 λrms or less.

6. The optical pickup device of claim 5, wherein the movement limits are mechanical limits.

7. The optical pickup device of claim 5, wherein the movement limits are electrical limits.

8. The optical pickup device of claim 5, wherein when the second actuator moves the objective lens in an optical axis intersection direction during a tracking or seeking operation, if a movement of the objective lens is limited by the movement limit of the objective lens, the first actuator moves the subcarriage.

9. The optical pickup device of claim 8, further comprising a third actuator for moving the carriage base,
wherein when the first actuator moves the subcarriage, if a movement of the subcarriage is limited by the movement limit of the subcarriage, the third actuator moves the carriage base.

10. The optical pickup device of claim 5, further comprising a moving amount calculation section for calculating a moving amount of a convergent spot on the information recording surface of the first or second optical information recording medium based on a signal from the outside during the seeking operation, and a judgment section for judging whether the objective lens is limited or not by the movement limit of the objective lens when the second actuator moves the objective lens by an amount equal to the moving amount of the convergent spot calculated by the moving amount calculation section,
wherein when the judgment section judges that the objective lens is limited by the movement limit of the objective lens, the first actuator moves the subcarriage before the second actuator moves the objective lens.

11. The optical pickup device of claim 10, further comprising the moving amount calculation section for calculating the moving amount of the convergent spot on the information recording surface of the first or second optical information recording medium based on the signal from the outside during the seeking operation, and the judgment section for judging whether the objective lens is limited by the movement limit of the objective lens and whether the subcarriage is limited by the movement limit of the subcarriage when the second actuator moves the objective lens by an amount equal to the moving amount of the convergent spot calculated by the moving amount calculation section and the first actuator moves the subcarriage,
wherein when the judgment section judges that the objective lens is limited by the movement limit of the objective lens and the subcarriage is limited by the movement limit of the subcarriage, the third actuator moves the subcarriage before the first and second actuators move the subcarriage and the objective lens.

12. The optical pickup device of claim 1, further comprising an eccentricity calculation section for calculating an eccentric component of one rotation cycle of the first or second optical information recording medium,
wherein when information is recorded and/or reproduced in the same track for one rotation or more of the first or second optical information recording medium, the first actuator moves the subcarriage in an optical axis orthogonal direction in synchronization with the rotation based on the eccentric component of one rotation cycle.

13. The optical pickup device of claim 1, wherein the divergent angle changing optical system comprises a plurality of lenses, and at least one of the lenses is moved in an optical axis direction by a fourth actuator.

14. The optical pickup device of claim 13, wherein the fourth actuator comprises an electromechanical conversion element, a driving member fixed to one end of the electromechanical conversion element, and a movable member connected to at least one of the lenses and held on the driving member so as to be movable, and the electromechanical conversion element is repeatedly expanded and contracted by changing speeds between expansion and contraction directions to move the movable member.

15. The optical pickup device of claim 1, wherein the first actuator comprises an electromechanical conversion element, a driving member fixed to one end of the electromechanical conversion element, and a movable member connected to the subcarriage and held on the driving member so as to be movable, and the electromechanical conversion element is repeatedly expanded and contracted by changing speeds between expansion and contraction directions to move the movable member.

16. The optical pickup device of claim 1, wherein the first actuator is a voice coil motor.

17. The optical pickup device of claim 16, wherein the subcarriage is supported by a leaf spring.

18. The optical pickup device of claim 1, wherein a beam of light having a wavelength λ1=405±20 nm is emitted from the light source, and one of the thickness t1 of the protective layer of the first optical information recording medium and the thickness t2 of the protective layer of the second optical information recording medium is 0.1 mm and the other is 0.6 mm.

19. The optical pickup device of claim 18, further comprising another light source for emitting a beam of light having a wavelength λ2=655±30 nm, wherein the beam of light having the wavelength λ2 is converged in an information recording surface of an optical information recording medium different from the first and second optical information recording media through the objective lens.

20. The optical pickup device of claim 18, further comprising another light source for emitting a beam of light having a wavelength λ3=785±30 nm,
wherein the beam of light having the wavelength λ3 is converged in an information recording surface of an optical information recording medium different from the first and second optical information recording media through the objective lens.
